(19) United States
(12) Patent Application Publication
(10) Pub. No.: US 2005/0119112 A1
(43) Pub. Date: Jun. 2, 2005

(54) Process for production of molecular sieve adsorbent blends

(75) Inventors: Armin Pfenninger, Uetikon (CH); Sonja Odolo-Hitz, Zug (CH); Kerry Weston, Louisville, KY (US); Beat Kleeb, Uetikon (CH); Dave Jaussaud, Louisville, KY (US)

Correspondence Address: Scott R. Cox, Ste. 2200, 400 West Market Street, Louisville, KY, 40202, US

(73) Assignee: Zeochem, LLC, Louisville, KY (US)

(21) Appl. No.: 10/939,751

(22) Filed: Sep. 13, 2004

Related U.S. Application Data
(63) Continuation-in-part of application No. 10/054,041, filed on Jan. 22, 2002, now Pat. No. 6,743,745.
(63) Continuation-in-part of application No. 10/765,018, filed on Jan. 26, 2004.

(51) Int. Cl. B01J 29/06

(52) U.S. Cl. 502/64

(57) ABSTRACT

A process for the production of a molecular sieve adsorbent blend with improved performance characteristics produced by preparing a zeolite material, which may include zeolite 13X, zeolite LSX or mixtures thereof, preparing a binder which includes highly dispersed attapulgite fibers alone or blended with a non-highly dispersed attapulgite clay, mixing the zeolite material with the binder to form a mixture, forming molecular sieve adsorbent blends into a shaped material and treating the shaped material, wherein the tapped bulk density of the highly dispersed attapulgite fibers measured according to DIN/ISO 787 is more than about 550 g/ml.

### CROSS REFERENCE TO RELATED APPLICATIONS

This application is a continuation-in-part of application Ser. No. 10/054,041, filed on Jan. 22, 2002, now U.S. Pat. No. 6,743,745 and application Ser. No. 10/765,018 filed on Jan. 26, 2004.

### BACKGROUND OF INVENTION

1. Field of Invention

This invention relates to molecular sieve adsorbents and more particularly to molecular sieve adsorbent blends comprising a mixture of different zeolitic materials blended with a binder containing at least partially highly dispersed attapulgite fibers. This invention also relates to a process for the preparation of molecular sieve adsorbent blends comprising mixing two or more different zeolite materials with a binder containing at least partially highly dispersed attapulgite fibers.

2. Background Art

Zeolites are hydrated metal alumina silicates having the general formula
M_{2/n}O:Al₂O₃:xSiO₂:yH₂O
where M usually represents a metal of the alkali or alkaline earth group, n is the valence of the metal M, x varies from 2 to infinity, depending on the zeolite structure type, and y designates the hydrated status of the zeolite. Most zeolites are three-dimensional crystals with a crystal size in the range of 0.1 to 30 μm. Heating these zeolites to high temperatures results in the loss of the water of hydration, leaving a crystalline structure with channels of molecular dimensions, offering a high surface area for the adsorption of inorganic or organic molecules. The adsorption capability of these molecules is limited by the size of the zeolite channels. The rate of adsorption is limited by the laws of diffusion.

A number of different zeolite particles of the faujasite-type have been prepared which resemble the natural mineral faujasite. Such zeolites are characterized by a relatively open zeolite framework with comparatively large micropores and high intracrystalline void volumes. Faujasites can be generally divided into zeolite X and zeolite Y. Synthetic zeolite X and Y differ by virtue of their silicon content with zeolite Y having a higher silicon:aluminum ratio. Type X zeolites can be further subdivided into low silicon type X zeolites (LSX), which are usually defined as being type X zeolites having a Si/Al atomic ratio of 1.0 to about 1.15. (SiO₂/Al₂O₃ ratio of about 2.0 to about 2.3). Type X zeolites with an Si:Al ratio of about 1.15 to about 1.5 usually are designated as 13 X zeolites (SiO₂/Al₂O₃ ratio of about 2.3 to about 3.0). Notwithstanding these designations of Si/Al content, the transition between zeolite 13 X and zeolite LSX is not clearly defined.

The synthesis of zeolite 13 X was first described in U.S. Pat. No. 2,882,244, while the synthesis of zeolite LSX was first disclosed in GB Patent 1,051,621.

An early application of synthetic faujasites was for the purification of air and other gaseous mixtures, especially prior to cryogenic distillation. Removal of carbon dioxide and water vapor in this process is of great importance as these two gases can condense and freeze during the cooling process, thus clogging the tubing and valves of the cryogenic distillation apparatus and preventing the production of liquid nitrogen and liquid oxygen.

The use of synthetic faujasite zeolites with SiO₂\Al₂O₃ ratio between 2.0 and 2.3 has proved especially useful for the absorption of carbon dioxide, especially at low partial pressures. This usefulness is disclosed in U.S. Pat. No. 5,531,808, which discloses a higher adsorption capacity of carbon dioxide on an LSX type zeolite compared to a 13 X type zeolite. Especially useful zeolites of this type contain sodium cations, as disclosed in WO 00/01478. See also WO 99/46031.

In addition to the use of a single type of zeolitic material, such as zeolite 13 X or zeolite LSX, it has also been discovered that it may be useful to combine two different types of zeolitic material to form an adsorbent. For example, U.S. Pat. No. 6,616,732 (WO 01/24923) discloses a zeolite blend comprised of zeolite 13 X and a zeolite LSX, wherein preferably 50 to 90% of the mixture is comprised of zeolite 13X and 50 to 10% of the blend is comprised of zeolite LSX. The exchangeable cationic sites on these zeolites are occupied at least about 80% with sodium cations or at least 70% with strontium cations, with the remaining cations being chosen from Group IA, IIA, and IIIA or trivalent ions from the rare earth or lanthanide series of the Periodic Table. The binder for this blend is selected from silica, alumina and clays. This adsorbent is particular suited to the decarbonation of gas flows contaminated with CO₂.

A composite adsorbent bed comprised of a conventional zeolite 13 X adsorbent and a lithium form of a zeolite X, utilized for vacuum pressure swing adsorption operations for air separation, is disclosed in U.S. Pat. No. 5,203,887.

The removal of impurities from a gaseous stream can be accomplished using different techniques. If the trace elements which need to be adsorbed are carbon dioxide and water vapor, the regeneration of the adsorption system is done through heating the system. This procedure is designated as TSA (Thermal Swing Adsorption). In an alternative procedure the adsorption and desorption may be achieved through changes of applied pressure. This procedure is designated as PSA (Pressure Swing Adsorption). The removal of impurities can be done with a column that is filled with a single type of adsorbent. Alternatively, the adsorbent column may be filled with layers of different types of adsorbents to remove each impurity using a selective procedure. Such techniques are disclosed in WO 96/14,916, EP 1092465 and U.S. Pat. No. 6,106,593.

One limitation on the utilization of zeolite crystals for these processes is their extremely fine particle size. Naturally-formed agglomerates of these crystals break apart easily. Because the pressure drop through a bed formed solely from those crystals is exceptionally high, these zeolite crystals cannot be used alone in fixed beds for dynamic applications, such as drying of natural gas, drying of air, separation of impurities from a gas stream, separation of liquid product streams and the like. To make zeolite particles useful for those processes, the crystals are blended with other materials to provide an agglomerate mass which exhibits a reduced pressure drop.

Different types of clays may be used as binders for these zeolite crystal blends, including attapulgite, palygorskite, kaolin, sepiolite, bentonite, montmorillonite and mixtures thereof. For example, U.S. Pat. No. 2,973,327 discloses the use of a number of different types of clays, including attapulgite, as a binder for molecular sieves. The clay content of the bonded molecular sieve can vary from as low as 1 percent to as high as 40 percent by weight, although the preferred range is from about 10 to about 25 percent by weight.

An adsorbent for separating gases comprising a binder and a crystalline, low silica faujasite-type zeolite with a silica to alumina molar ratio of 1.9 to 2.1 is disclosed in EP 0 940 174 A2.

One problem with conventionally formed zeolite blends is decreased diffusion. The larger the diameter of the formed zeolites, the slower the rate of diffusion of the molecules to be adsorbed. Particularly in the field of pressure swing adsorption, this effect is highly adverse to short cycle time and thus to productivity. Enhanced kinetic values or faster mass transfer rates can result in shorter cycle time and lower power consumption and thus higher adsorbent productivity.

It has been recognized that a reduction in the particle size of formed zeolites leads to shorter mass transfer zones and shorter cycle times. This is based on the assumption that the time needed for adsorbates to travel through the macropores of the adsorbents limits the cycle time, i.e. macropore diffusion is the rate limiting step in these processes. This problem can be improved by adding pore forming compounds to the zeolite clay blend before the forming step.

It is an object of the invention to disclose an improved molecular sieve adsorbent blend comprising a blend of different zeolite materials with a highly dispersed attapulgite binder which can be utilized for a number of different adsorption processes.

This and other objects are obtained by the process for production, the process for use and product of the invention disclosed herein.

### SUMMARY OF THE INVENTION

The present invention is a process for the production of a molecular sieve adsorbent blend with improved performance characteristics comprising
preparing a mixture of different zeolite materials,
preparing a binder, at least partially comprising highly dispersed attapulgite fibers, wherein the tapped bulk density of the highly dispersed attapulgite fibers, is above 550 g/l as measured according to DIN/ISO 787,
combining the mixture of different zeolite materials with the binder to form a blended zeolite binder product, and
treating the combined product to form the molecular sieve adsorbent blend.

The present invention is also a molecular sieve adsorbent blend comprising
a mixture of different zeolite materials blended with a binder, wherein the binder at least partially comprises highly dispersed attapulgite fibers, wherein the tapped bulk density of the highly dispersed attapulgite fibers is above 550 g/l as measured according to DIN/ISO 787.

The present invention is also a process for drying a feed stream comprising passing the feed stream over a molecular sieve adsorbent blend comprising a mixture of two or more different zeolite materials blended with a binder, wherein the binder at least partially comprises the highly dispersed attapulgite fibers, as defined above.

The invention is also a process for the separation of components of a gaseous or liquid feed stream comprising passing the feed stream over a molecular sieve adsorbent blend comprising a mixture of different zeolite materials blended with a binder, at least partially comprising the highly dispersed attapulgite fibers, as defined above.

### DETAILED DESCRIPTION OF THE INVENTION

The present invention is a molecular sieve adsorbent blend formed from a mixture of different zeolite materials blended with a binder, wherein the binder comprises at least partially highly dispersed attapulgite fibers, a process for formation of that blend, and processes of use of that blend. The invention is based on the discovery that the adsorption rate of a molecular sieve adsorbent product is dependent not only upon the nature and composition of the zeolite materials, but also the type and characteristics of the binder blended with the zeolite materials. It has been surprisingly discovered that the same type and quantity of mixtures of different zeolite materials when blended with different binders produces molecular sieve adsorbent blends exhibiting varying adsorption characteristics depending upon the binder that is used. (The phrases “adsorption rate”, “sorption rate” or “mass transfer rate” mean the rate at which an adsorbate loading in a feed stream changes over a given period of time for a given adsorption/separation process.)

The prior art suggests that the adsorption rate of a particular molecular sieve adsorbent is only a function of the porosity and particle size of the particular zeolite material utilized. It has now been surprisingly discovered that the type of binder that is used to bind the zeolite crystals together also plays an important role in the adsorption rate of the material.

Adsorbent molecular sieve aggregates or blends are formed by mixing zeolite materials with binder materials. Various types of zeolites may be used to form the adsorbent blends including zeolite A, zeolite X, including zeolite 13 X and LSX, zeolite Y, zeolite ZSM-5, zeolite Beta, synthetic mordenite and blends thereof. These zeolites may be used singly or in mixtures of two or more zeolites. The particular type of zeolite present in the blend depends upon the adsorbate that is to be adsorbed from the feed stream. For example, when the desired adsorbate is carbon dioxide in a gas stream, the preferred zeolites are zeolite X, including zeolite 13 X and zeolite LSX. When the adsorption process is for the purification of gases, notably by pressure swing adsorption (PSA) and temperature swing adsorption (TSA) methods, the preferred zeolites include zeolite A or zeolite X, including zeolite 13 X.

One of the important uses for these zeolitic materials is for the removal of carbon dioxide, water and other trace inorganic gases, as well as various hydrocarbons, from a gas stream, especially air. These trace gases can be selectively adsorbed by the zeolitic adsorbent. To improve the adsorption of trace gases, such as carbon dioxide, the zeolite or zeolite mixture should be optimized. For example, it has been shown that zeolites with a low SiO₂/Al₂O₃ ratio exhibit a higher adsorption capacity for carbon dioxide than zeolites with a higher SiO₂/Al₂O₃ ratio. In particular, when zeolite 13 X is replaced by zeolite LSX, the breakthrough time for the adsorption of carbon dioxide from an air stream can be extended, as zeolite LSX has a higher adsorption capacity than zeolite 13 X. Notwithstanding, because of the increased cost of zeolite LSX, the use of zeolite 13 X is often preferred.

Binder materials are utilized to bind individual zeolite crystals together, to form shaped products and to reduce the pressure drop during the adsorption process. In the past the binder material has not enhanced the adsorption capability of the zeolite materials. In fact, conventional binders have generally reduced the adsorption capacity of the zeolites materials. Binders which have been utilized with zeolite materials in the past include clay minerals, such as kaolin, palygorskite-type minerals, such as attapulgite, and smectite-type clay minerals, such as montmorillonite or bentonite. These clay binder materials have been used singly or in mixtures of two or more different types of clay binders.

The inventors have surprisingly discovered that a particularly useful blend of zeolite materials and a binder material is produced when at least a portion of the binder materials is an attapulgite clay which contains “highly dispersed attapulgite fibers.” Generally speaking, clay particles, especially attapulgite clay particles, exist as dense materials with very limited adsorption capabilities. These conventional clay binder particles are different in size and shape from the zeolite materials. When blended with zeolite materials, they tend to occupy space between the zeolite materials without increasing the overall adsorption of the blend.

In particular, attapulgite clay particles, even after mining and work-up, are naturally formed in dense bundles of clumped bristles or fibers. The existence of these bundles has been confirmed using scanning electron microscopy (SEM). These fibers must be separated or ground to permit their use as binders for zeolite materials. Without grinding these attapulgite clay bundles to a smaller size, a non-porous layer of attapulgite clay fibers is created in the zeolite blend, preventing or substantially limiting, diffusion of adsorbates through the blend. The conventional attapulgite clays that have been utilized are produced by dry grinding the attapulgite clay. In this conventional process these dry ground attapulgite clay bundles of fibers are then blended with the zeolite materials. However, even after conventional grinding of the attapulgite clay fibers, large bundles of attapulgite clay fibers are still present. When these conventional attapulgite clay bundles are blended with zeolite materials and formed into adsorbent blends, the capability of the zeolite materials to adsorb the desired adsorbate is not enhanced.

The applicants' invention utilizes “highly dispersed” attapulgite clay fibers as at least a portion of the binder material that is blended with the zeolite materials.

Dense attapulgite clay bundles of fibers can be differentiated from “highly dispersed” attapulgite clay fibers of the invention readily through the use of scanning electron microscopy. Another method to distinguish between conventional dense attapulgite clay fibers and the “highly dispersed” attapulgite clay fibers of the invention is by the use of tapped bulk density measurement as determined according to DIN/ISO 787. Dense attapulgite clay binder fibers contain a residual water content of about 20-25 percent and have a tapped bulk density of about 400 g/l to about 530 g/l. “Highly dispersed” attapulgite binder fibers also contain residual water of about 20-25 percent but have a tapped bulk density of about 550 g/l to about 700 g/l.

Another method to distinguish between conventional dense attapulgite clay fibers and highly dispersed attapulgite clay fibers of the invention is by determining the water adsorption capacity of the respective attapulgite clay fibers. To determine whether the clay fibers are “highly dispersed”, the clay fibers are fully saturated at 50 percent relative humidity at 25° C. until an equilibrium adsorption capacity is achieved. This process may take up to 72 hours. After full hydration of the clay is achieved, the clay is dried at 550° C. for at least two hours. The difference in the weight between the fully hydrated clay and the dried clay is the water adsorption capacity. For dense attapulgite clay fibers, the water adsorption capacity is below 30 percent, whereas for the “highly dispersed” attapulgite clay fibers, the water adsorption capacity is above 35 percent.

While any process which produces attapulgite fibers which are “highly dispersed”, as defined above, is within the scope of the invention, one preferred process is disclosed in U.S. Pat. No. 6,130,179, the contents of which are incorporated by reference into this application. The process of U.S. Pat. No. 6,130,179 utilizes a dispersant which disperses the individual attapulgite clay fibers in water such that they remain in suspension even after other materials, including other clays and mineral species, are removed from that solution. Once the “highly dispersed” attapulgite clay fibers are prepared, they are ready for use in the production of the molecular sieve adsorbent blends of the invention. Notwithstanding, this patent fails to disclose or suggest the use of these highly dispersed attapulgite clay fibers with zeolite.

Generally the process to produce the molecular sieve adsorbent blend with improved performance characteristics according to the invention is as follows:
prepare the zeolite materials, which may comprise a mixture of different zeolite materials,
prepare an attapulgite binder, at least partially comprising highly dispersed attapulgite fibers,
mix the zeolite material or different zeolite materials with the attapulgite fibers, preferably in an aqueous mixture,
form an uncalcined blended product from the mixture, and
calcine the blended product to form the molecular sieve adsorbent blend product of the invention.

Once the appropriate zeolite materials are chosen for a given application, they are mixed with the binder, which must be comprised at least partially of the highly dispersed attapulgite fibers, in the presence of a liquid, preferably water. The zeolite material and the binder, which must be comprised at least partially of the highly dispersed attapulgite fibers, are blended together preferably with the water. The amount of binder that is utilized can range from 5 to about 30 percent by weight, preferably from about 5 to about 20 percent and most preferably in the range of about 10 percent of the product. In contrast, conventional mixtures of zeolite materials and non-highly dispersed attapulgite clay binders are required to utilize about 20 percent or more attapulgite clay.

The highly dispersed attapulgite binder fibers comprise at least 10 percent, by weight, preferably at least 20 percent by weight and most preferably at least 50 percent by weight of the total binder material utilized to produce the adsorbent blend product. The remaining binder material may be conventional attapulgite binder. Sufficient water is retained in or added to the mixture to make a formable mixture, i.e., one that can be easily extruded.

The components of the mixture are blended using a conventional blending device, such as a conventional mixer, until a mass of suitable viscosity for forming the end product is obtained. The blended mixture is then formed into the appropriate shaped product, for example, by extrusion. The products can be formed in any conventional shape such as beads, pellets, tablets or other such conventional shaped products. Once the formed products are produced into the appropriate shape, they are calcined, preferably at about 600° C., for about 30 minutes to 2 hours.

In an optional preferred embodiment, a pore forming agent may be added to the zeolite/attapulgite clay mixture during the mixing step to enhance the total pore volume of the end product. Among acceptable pore forming agents are fibers, including rayon, nylon, sisal, flax and the like and organic polymers, including corn starch, starch derivatives, lignosulfonates, polyacrylamide, polyacrylic acid, cellulose, cellulose derivatives and the like. The amount of the pore forming agent that may be added is from about 2 to about 15 percent, by weight.

When the adsorbent blend is to be utilized to adsorb trace gases, particularly from air using a pressure swing absorption or thermal swing absorption, improved adsorption occurs when the zeolitic material is zeolite LSX. Zeolite LSX has a longer break through time for carbon dioxide adsorption than does zeolite 13 X. When the conventional attapulgite clay binder is replaced by the highly dispersed attapulgite clay fiber disclosed in the invention, the break through time for a blend containing only zeolite 13 X, is almost the same as when the conventional attapulgite clay binder is used. However, it has been surprisingly discovered that when the zeolite 13 X is replaced by zeolite LSX, the break through time for the blend of the zeolite LSX with the highly dispersed attapulgite fibers is substantially greater than when the zeolite LSX is combined with a conventional attapulgite binder. For example, when pure zeolite LSX is used with highly dispersed attapulgite fiber comprising about 12 percent of the blend, the increase in the break through time is at least 50 percent and preferably about 67 percent. In contrast, when the zeolite LSX is used with a conventional attapulgite binder of the same concentration, the break through time only increased about 35 percent. Notwithstanding, significant improvements occur in the break through time when the amount of zeolite 13 X that is replaced with LSX is as little as 20 percent, preferably at least 25 percent and in a most preferred embodiment at least 40 percent. In one preferred embodiment the ratio of the zeolite 13X to the zeolite LSX is from about 75:25 to about 60:40.

The zeolitic materials when formed using conventional procedures contain a high percentage of sodium cations, generally at least about 90 percent. The remaining cations are generally potassium cations usually in the range from about 1 to about 10 percent. It has been surprisingly discovered that the adsorption capability of the composition can be improved by reducing the sodium ions to 5 percent or less, maintaining the potassium ions at 25 percent or less and ion exchanging the remaining cations of the zeolitic material with alkaline earth metal cations, especially calcium cations, preferably from about 50 to about 95 percent, and most preferably from about 75 to about 85 percent. Any remaining cations can be comprised of alkali metals, such as sodium or potassium, preferably potassium, other alkaline earth metal cations, Group IIIB cations, or cations from the lanthanide series.

Products produced by the process of the invention show improved adsorption rates. The adsorption rate can be determined using several different methods. For example, in one preferred process, the adsorbent product produced according to the invention can be tested to determine the time necessary to achieve 95 percent of the maximum adsorption capacity of the material. The shorter the time to achieve this value, the faster the adsorption rate.

In another process to determine the adsorption rate of the molecular sieve adsorbent blend of the invention, the amount of the adsorbed product that has been adsorbed over a given period of time can be determined.

In a further process of comparison of adsorption, the mass transfer zone of the blend of the invention can be compared to that of a conventional blend under given conditions. The shorter the mass transfer zone, the higher the adsorption rate.

Finally, the diffusion rate can be determined directly for certain gases or liquids. The higher the diffusion rate, the faster the adsorption rate.

It has been surprisingly discovered that by replacing some or all of a conventional attapulgite binder with “highly dispersed” attapulgite fibers, there is an improved adsorption rate, regardless of which method is used to measure that rate. The improvement in adsorption rate is at least about 10 percent and may be as high as 200 percent compared to products wherein only conventional attapulgite clay binders are used. This improvement is important because of the higher cost of the highly dispersed attapulgite fibers over conventional attapulgite binders.

A further surprising improvement is the ability of the molecular sieve adsorbent blend to maintain its crush strength even when the amount of the highly dispersed attapulgite fibers that are added is less than is used with conventional attapulgite clay binders. Generally speaking, the more binder that is present, the better the crush strength of the finished product. For conventional dense attapulgite binders, this improvement in crush strength is dramatic when the percentage of attapulgite binder within the end product increases from 10 to about 20 percent of the composition. Products made with conventional dense attapulgite binder of 10 percent or less are not practical as their crush strength drops below acceptable levels. It has been surprisingly discovered that a product produced using the highly dispersed attapulgite fibers of the invention produce an end product with adequate crush strength even when the quantity of the highly dispersed attapulgite fibers in the end product is as low as 10 percent or even less. Further, at any particular percentage of binder material, the crush strength of a product produced using the highly dispersed attapulgite fibers of the invention is higher than for a product made solely with a conventional dense attapulgite binder.

It has also been surprisingly discovered that even when lower percentages of highly dispersed attapulgite fibers are utilized in an adsorbent product than conventionally are used when a conventional dense attapulgite clay is used, the rate of water adsorption increases. This is evidenced by a reduction in the amount of time that is necessary to achieve a particular predetermined amount to be adsorbed. This improvement is at least 10 percent and in many cases as much as 30 percent or more.

While it is known that improved adsorption occurs, particularly of trace gases using a TSA or PSA procedure for the purification of air, when the zeolitic material that is used is a zeolite LSX in contrast to a zeolite 13 X, it has been surprisingly discovered that this improvement is greater than expected when some or all of the conventional attapulgite binder, that is normally utilized in the production of the adsorbent material, is replaced with the “highly dispersed” attapulgite fibers of the invention.

The highly dispersed attapulgite fibers or blend of conventional attapulgite binder and highly dispersed attapulgite fibers can be combined with various mixtures of zeolites and used for a number of different processes. For example, the blend can be used for drying a feed stream, such as for the removal of water from a gaseous or liquid ethanol stream. The blend can also be used for the separation of nitrogen from an air stream. Further, the blend can be used for the removal of sulfur and oxygen containing compounds from a hydrocarbon stream. Another use for this blend is for the removal of carbon monoxide, carbon dioxide and nitrogen from a hydrogen gas stream. The blend can also be used for the removal of water from a gaseous or liquid hydrocarbon stream or for the removal of water from a gaseous or liquid stream of refrigerants. Another use is for the removal of water and carbon dioxide from air. The adsorbent blend of the invention may also be used for the separation of organic compound, such as for the separation of n-paraffins from a mixture of iso-paraffins and n-paraffins or for the conversion of certain organic compounds. There are a number of other processes for which this blend of a binder, comprising at least partially highly dispersed attapulgite fibers, and mixture of different zeolites can be utilized which would be well known to a person skilled in the art and which are covered by this invention.

These improvements are shown by the following examples:

### EXAMPLES

### Example 1

Samples of an attapulgite clay material that is conventionally used as a binder for zeolites and highly dispersed attapulgite clay fibers were tested for tapped bulk density, residual water and water adsorption capacity. Tapped bulk density was determined according to DIN/ISO 787.

(Actigel 208 obtained from ITC Floridin was used as the highly dispersed attapulgite clay in all examples. The conventional attapulgite clays were of different brands and obtained from ITC Floridin.)

A clay sample of about 10 grams was weighed in a porcelain crucible (weighing precision 1 mg) and heated to 550° C. for 2 hours. The sample was cooled to room temperature in a desiccator and weighed (weighing precision 1 mg). The weight difference led to the residual water amount.

Another clay sample of about 10 grams was weighed in a porcelain crucible (weighing precision 1 mg) and was water saturated at 50 percent relative humidity and 20° C. The equilibrium was reached within 72 hours. The sample was weighed (weighing precision 1 mg) and heated to 550° C. for 2 hours. The sample was cooled to room temperature in a desiccator and weighed (weighing precision 1 mg). The weight difference of the fully hydrated sample and fully dried sample led to the water adsorption capacity given in Table 1 below. The fully dried mass was taken as 100 percent clay.

TABLE 1

| | | Attapulgite Clay Sample | | |
|---|---|---|---|---|
| | Highly | Conventional | Conventional | Conventional |
| | Dispersed | Dense | Dense | Dense |
| | Clay | Clay 1 | Clay 2 | Clay 3 |
| Tapped Bulk | 617 | 398 ± 31 | 529 ± 20 | 428 |
| Density (g/ml) | 595 | (average of | (average of | 459 |
| | 660 | 17 samples) | 21 samples) | |
| Residual Water | 22.3 | 25.5 | 21.4 | 25.5 |
| as Received (%) | 21.7 | | | 22.6 |
| | 23.7 | | | |
| Water | 36.8 | 28.8 | 25.0 | 29.7 |
| Adsorption | 36.0 | | | 28.8 |
| Capacity (%) | 36.0 | | | |

As is clear from the Table, the bulk density of the highly dispersed clay was significantly higher than the bulk density of the conventional dense attapulgite clay. In addition, the water adsorption capacity of the highly dispersed attapulgite clay fibers was significantly higher than that of the conventional dense attapulgite clay.

### Example 2

The crush strength of samples of a molecular sieve adsorbent blend product prepared using a conventional dense attapulgite clay was compared with a molecular sieve adsorbent blend product prepared using a highly dispersed attapulgite clay.

To determine the crush strength of the various samples, molecular sieve blends were prepared. Sodium A molecular sieve was blended with various amounts of both a conventional dense attapulgite clay and the highly dispersed attapulgite clay. To 100 grams of the molecular sieve/clay binder mixture about 30 to 40 grams of water were added and then blended for up to 180 minutes using a conventional blender. The product was then extruded in the form of 1/16″ extrudates. These extrudates were then dried at approximately 120° C. for 8 to 12 hours and then calcined at 600° C. for about 2 hours.

TABLE 2
Crush Strength in Relation to the Amount of Binder Used

| | Con- | | | | | |
|---|---|---|---|---|---|---|
| | ven- | Conven- | Conven- | Highly | Highly | Highly |
| | tional | tional | tional | Dis- | Dis- | Dis- |
| | Dense | Dense | Dense | persed | persed | persed |
| | Binder | Binder | Binder | Binder | Binder | Binder |
| | (20%) | (15%) | (10%) | (20%) | (15%) | (10%) |
| Size of | 1/16″ | 1/16″ | 1/16″ | 1/16″ | 1/16″ | 1/16″ |
| Extrudates | | | | | | |
| Crush | 19.9 | 8.8 | 7.5 | 28.5 | 19.6 | 16.1 |
| Strength | | | | | | |
| [N] | | | | | | |

Surprisingly the crush strength of a product made with 20 percent highly dispersed attapulgite fibers was significantly greater than a product made with the same percentage of a conventional dense attapulgite binder. Further, the crush strength remained at a reasonably high level even when the amount of the highly dispersed attapulgite fiber was reduced to 10 percent, whereas the crush strength of the material using the conventional attapulgite binder dropped rather significantly.

### Example 3

### Water Adsorption Kinetics

The materials prepared in Example 2 were tested for water adsorption kinetics. It was surprisingly discovered that the amount of binder did not have an impact on the water adsorption kinetics of the material made with the conventional binder. In contrast, it was surprisingly discovered that when the amount of the highly dispersed attapulgite fiber was reduced to 10 percent, the rate of adsorption of water to reach 95 percent of adsorption capacity increased dramatically. Details are shown in the attached Table 3.

TABLE 3
Influence of Binder Type and Binder Amount
to Water Adsorption Kinetics

| | Con- | Con- | | | | |
|---|---|---|---|---|---|---|
| | ven- | ven- | Conven- | Highly | Highly | Highly |
| | tional | tional | tional | Dis- | Dis- | Dis- |
| | Dense | Dense | Dense | persed | persed | persed |
| | Binder | Binder | Binder | Binder | Binder | Binder |
| | (20%) | (15%) | (10%) | (20%) | (15%) | (10%) |
| Size of | 1/16″ | 1/16″ | 1/16″ | 1/16″ | 1/16″ | 1/16″ |
| Extrudates | | | | | | |
| H₂O | 121 | 130 | 122 | 136 | 133 | 96 |
| Adsorption | | | | | | |
| Kinetics at | | | | | | |
| 1 mbar [min] | | | | | | |

### Example 4

### Beaded Molecular Sieve 3A

A premixed zeolite 3A powder/attapulgite clay composition was added continuously to a granulation pan. The zeolite 3A powder was acquired from Zeochem AG. During the beading process, water was sprayed on the powder mixture to maintain a constant humidity. The powder mixture was added at a speed of 300 kg/hr. After having finished the addition of the powder mixture, the beads were rolled for another 10 minutes. The green beads were dried at 100° C. and then calcined at 600° C. The calcined beads were stored in well closed containers and analyzed. Table 4 gives the comparative results for the two different beaded materials. While physical properties, such as crush strength and bulk density were generally the same for both samples, mass transfer zone was reduced significantly and water adsorption rate was surprisingly faster for the product made with the highly dispersed attapulgite clay.

TABLE 4
Comparative Results of a Conventional 3A Molecular Sieve and a
Molecular Sieve Produced with 10% Highly Dispersed Attapulgite
Clay as a Beneficiated Attapulgite Binder

| | Reference Material | According to Invention |
|---|---|---|
| | (20% Dense | (10% Highly Dispersed |
| | Attapulgite Binder) | Attapulgite Clay) |
| Bead Size [mesh] | 4 × 8 | 4 × 8 |
| Crush Strength [N] | 51 | 46 |
| Bulk Density [g/l] | 721 | 687 |
| Water Adsorption | 20.1 | 21.3 |
| 50% r.h. [%] | | |
| Water Mass Transfer | 253 | 167 |
| Zone [mm] | | |
| Water Adsorption | 184 | 105 |
| Kinetic (time to | | |
| reach 95% ads. | | |
| capacity; 4 mbar) | | |
| [min] | | |

### Example 5

### Beaded Molecular Sieve 3A for Natural Gas Drying

A premixed zeolite 3A powder/organic additive/clay composition was added continuously to a granulation pan. During the beading process, water was sprayed onto the powder mixture to keep a constant humidity. The powder mixture was added at a speed of 300 kg/hr. After having finished the addition of the powder mixture, the beads were rolled for another 10 minutes. The green beads were dried at 100° C. and then calcined at 630° C. The calcined beads were stored in closed containers and analyzed. The amount of organic additive was kept constant for both experiments. Table 5 gives the comparative results of the two different beaded materials. While physical properties, attrition, and bulk density are generally the same for both samples, water adsorption rate increased surprisingly for the product produced using the highly dispersed attapulgite clay. The beads are much smaller than in Example 4, but the increase in the adsorption rate was still very high, indicating that the effect is intrinsic.

TABLE 5
Comparative Results of a Conventional 3A Molecular Sieve Used
for Natural Gas Drying and a Molecular Sieve Produced with
10% Highly Dispersed Attapulgite Clay as a Beneficiated Attapulgite

| | Reference Material | |
|---|---|---|
| | (20% Conventional | According to Invention |
| | Dense Attapulgite | (10% Highly Dispersed |
| | Binder) | Attapulgite Clay) |
| Bead Size [mesh] | 8 × 12 | 8 × 12 |
| Attrition [%] | 0.04 | 0.02 |
| Bulk Density [g/l] | 730 | 722 |
| Water Adsorption | 22.2 | 22.7 |
| 50% r.h. [%] | | |
| Water Adsorption | 14.1 | 18.5 |
| Kinetic at p/p₀ = 0.03, | | |
| after 120 min. [%] | | |

### Example 6

### Beaded Molecular Sieve 5A

A premixed zeolite 5A powder/clay composition was added continuously to a granulation pan. The zeolite 5A powder was acquired from Zeochem Ltd. During the beading process, water was sprayed onto the powder mixture to keep a constant humidity. The powder mixture was added at a speed of 300 kg/hr. After having finished the addition of the powder mixture, the beads were rolled for another 10 minutes. The green beads were dried at 100° C. and then calcined at 630° C. The calcined beads were stored in closed containers and analyzed. Table 6 gives the comparative results of the two different beaded materials. While butane adsorption capacity increased within expectations, nitrogen adsorption kinetic increased surprisingly, certainly more than was anticipated.

TABLE 6
Comparative Results of a Conventional 5A Molecular Sieve and a
Molecular Sieve Produced with 10% Highly Dispersed Attapulgite
Clay as a Beneficiated Attapulgite Binder

| | Reference | |
|---|---|---|
| | Material (20% | According to Invention |
| | Conventional Dense | (10% Highly Dispersed |
| | Attapulgite Binder) | Attapulgite Clay) |
| Bead Size [mesh] | 8 × 12 | 8 × 12 |
| N-Butane Adsorption | 8.0 | 9.3 |
| Capacity; 1 bar/25° C. | | |
| [%] | | |
| Nitrogen Kinetic | 0.17 | 0.39 |
| Value [1/s] | | |

### Example 7

### Beaded Molecular Sieve 4A

The same preparation procedure was used as in Example 6, except that zeolite 4A powder acquired from Zeochem AG was used for the beading process. The amount of the binder for the new formulation was increased to 15%. The drying and the calcination process followed the same temperature profiles as was used in Example 6. The results are given in Table 7. The Example using 15% of the highly dispersed attapulgite binder showed a surprising improvement in the adsorption rate. The mass transfer zone dropped from 137 mm to 106 mm and the water adsorption capacity after 120 minutes increased from 15.0% to 17.2%.

TABLE 7
Comparative Results of a Conventional 5A Molecular Sieve and a
Molecular Sieve Produced with 15% Highly Dispersed Attapulgite
Clay as a Beneficiated Attapulgite Binder

| | Reference | |
|---|---|---|
| | Material (20% | According to Invention |
| | Conventional Dense | (15% Highly Dispersed |
| | Attapulgite Binder) | Attapulgite Clay) |
| Bead Size [mm] | 2-3 | 2-3 |
| Crush Strength [N] | 57 | 41 |
| Attrition [%] | 0.03 | 0.01 |
| Bulk Density | 729 | 710 |
| [g/l] | | |
| Water Mass Transfer | 137 | 106 |
| Zone [mm] | | |
| Water Adsorption | 15.0 | 17.2 |
| Kinetic at p/p₀ | | |
| (after 120 min.) | | |
| [%] | | |

### Example 8

### Beaded Molecular Sieve 13X Used for Air Purification and/or for Air Separation

A premixed zeolite 13X powder/organic additive/clay composition was added continuously to a granulation pan. The 13X zeolite powder was acquired from Zeochem AG. During the beading process, water was sprayed onto the powder mixture to keep a constant humidity. The powder mixture was added at a rate of 500 kg/hr. After having finished the addition of the powder mixture, the beads were rolled for another 10 minutes. The green beads were dried at 100° C. and then calcined at 620° C. The calcined and cooled beads were stored in air tight containers and analyzed. The analytical results of the finished product are given in Table 8. Again, the physical properties remained within expectations, but the adsorption rate increased for the composition of the invention much more than expected, especially for the adsorption of nitrogen.

TABLE 8
Comparative Results of a Conventional 13X Molecular Sieve Used
for Air Prepurification and for Air Separation, and a Molecular Sieve
Produced with 10% Highly Dispersed Attapulgite Clay as a
Beneficiated Attapulgite Binder

| | Reference Material | |
|---|---|---|
| | (16% Dense | According to Invention |
| | Conventional | (10% Highly Dispersed |
| | Attapulgite Binder) | Attapulgite Clay) |
| Bead Size [mm] | 1.0-2.0 | 1.0-2.0 |
| Attrition [%] | 0.05 | 0.07 |
| Bulk Density [g/l] | 640 | 638 |
| Water Adsorption | 28.1 | 30.7 |
| Capacity 50% r.h. | | |
| [%] | | |
| CO₂ Adsorption | 12.6 | 13.6 |
| Capacity 45 mbar/25° C. | | |
| [%] | | |
| Water Adsorption | 17.0 | 19.2 |
| Kinetic at p/p₀ = 0.03 | | |
| (after 120 min.) [%] | | |
| Nitrogen Kinetic | 0.20 | 0.33 |
| Value [1/s] | | |

As is shown from these examples, there are surprising improvements in the performance of molecular sieve adsorbent blends using attapulgite binder produced from highly dispersed attapulgite fibers. This improvement in crush strength, adsorption kinetics and other characteristics as shown in the Examples was surprising and dramatic.

### Example 9

### Beaded Molecular Sieve 13 X Used for Air Purification Using Conventional Attapulgite Binder (Comparative Example)

A zeolite 13 X powder, organic additive, and conventional attapulgite clay binder mixture was added continuously to a granulation wheel. The 13 X zeolite powder was obtained from Zeochem AG, Uetikon, Switzerland, and the attapulgite binder was obtained from ITC Floridin, Hunt Valley, Md. and is of the type disclosed in Example 1. During the granulation process sufficient water was sprayed on the zeolite and binder in order to maintain sufficient humidity to obtain a beaded material. The powder mixture was added at a rate of 500 kg/hr. After the entire mixture was added to the wheel, the finished beads were rolled for an additional ten minutes. The final mixture contained 16 percent binder by weight. The green beads were screened to a grain size of 1.6-2.6 mm, dried at a 100° C. and calcined at a temperature of 620° C. The calcined and cooled material was packed in air tight drums and analyzed. The break through time for carbon dioxide was 158 minutes.

### Example 10

### Beaded Zeolite 13 X/LSX for Air Purification Using a Blend of a Highly Dispersed Attapulgite Binder and a Conventional Attapulgite Binder

A mixture of sodium LSX zeolite and 13 X zeolite (mixed at a ratio of 33:67 LSX:13X), organic additives and a mixture of highly dispersed attapulgite fibers and a conventional attapulgite binder (mixed in a ratio of 33:67 highly dispersed to conventional attapulgite) were added continuously to a granulation wheel. The zeolite materials were obtained from Zeochem AG with both the highly dispersed attapulgite clay fibers and the conventional attapulgite clay binder obtained from IT Floridin. (See Example 1) These zeolitic and binder materials were used for all remaining Examples. During the granulation process, water was sprayed on the zeolite and binder mixture in order to maintain a constant humidity sufficient to obtain beaded material. The powdered mixture was added at a rate of 500 kg/hr. After having finished the addition of the powder material, the beads were rolled for an additional ten minutes. The green beads were dried at a temperature of 100° C. and then calcined at 620° C. The calcined and cooled beads were stored in air tight containers and analyzed. The final mixture contained 12 percent binder by weight. The break through time for carbon dioxide was at 206 minutes.

### Examples 11 through 16

Production of beaded zeolite 13 X/LSX for air purification containing a blend of highly dispersed attapulgite fibers and conventional attapulgite binder. A number of zeolite blends were produced using various ratios of 13 X to LSX zeolite powders. To these mixtures organic additives were added. These mixtures were added to one or two attapulgite clay binders and moistened with water. 2 kg of the final blend were put in an Eirich laboratory mixer RO2. The material was mixed to a point were beads were formed. The green beads were strained to a size of 1.6-2.6 mm, dried at a 100° C. and calcined at 620° C. The calcined material was cooled under dry conditions, packed in air tight containers and analyzed.

Determination of Break Through Time.

The calcined and cooled zeolite materials were filled in an adsorption column with a diameter of 30 mm at a pressure of 6×10⁵ Pa, a temperature of 25° C. and a gas flow rate of 2.4 m³/hr, wherein the gas is purified nitrogen containing 450 ppm of carbon dioxide. The gas was passed through the column. The concentration of carbon dioxide is determined at the outlet of the adsorption column with an IR detector. The break through is achieved as carbon dioxide emerges at the outlet of the column.

### Example 11

Zeolite 13 X was used as the zeolitic material. The binder system comprised 50 percent highly dispersed attapulgite clay fibers and 50 percent conventional attapulgite clay binder from ITS Floridin. The amount of the binder in the finished product was 12 percent. The break through time was 161 minutes.

### Example 12

Zeolite 13 X and zeolite LSX were mixed at a ratio of 67:33. The clay binder system was a 50/50 mixture of the highly dispersed attapulgite fibers and a conventional attapulgite clay binder at a 12 percent mixture. The break through time was 192 minutes.

### Example 13

Zeolite 13 X and zeolite LSX were mixed together at a ratio of 50:50 with a binder system comprising highly dispersed attapulgite fibers and conventional attapulgite clay mixed at a ratio of 50:50. The binder comprised 12 percent of the mixture by weight. The break through time was 216 minutes.

### Example 14

A 100 percent zeolite LSX was used. The binder system comprised 12 percent of the mixture by weight and was comprised of 50 percent highly dispersed attapulgite fibers and 50 percent conventional attapulgite clay. The break through time was 269 minutes.

### Example 15. (Comparative Example)

100 percent zeolite LSX was used with a conventional attapulgite clay binder comprising 16 percent of the material by weight. The break through time was 213 minutes.

### Example 16. (Comparative Example)

Zeolite 13 X and zeolite LSX were combined at a ratio of 50:50 with a conventional attapulgite clay comprising 16 percent by weight. The break through time was 195 minutes.

As is clear from these Examples, improved performance is achieved when the binder used contains at least a portion of highly dispersed attapulgite clay fibers.

Although the invention has been described in detail, it is clearly understood that the same is by no way to be taken as a limitation. The scope of the present invention can only be limited by the appended claims.

1. A process for the production of a molecular sieve adsorbent blend with improved performance characteristics comprising
preparing a zeolite material comprising zeolite 13X and zeolite LSX;
preparing a binder comprising highly dispersed attapulgite fibers, wherein the tapped bulk density of the highly dispersed attapulgite fibers, as measured according to DIN/ISO 787, is more than about 550 g/l;
mixing the zeolite material with the binder in solution to produce a mixture;
treating the zeolite material binder mixture to form the molecular sieve adsorbent blend.

2. A process for the production of a molecular sieve adsorbent blend with improved performance characteristics comprising
preparing a zeolite material comprising zeolite 13X and zeolite LSX;
preparing a binder comprising a blend of highly dispersed attapulgite fibers and non-highly dispersed attapulgite fibers, wherein the tapped bulk density of the highly dispersed attapulgite fibers, as measured according to DIN/ISO 787, is more than about 550 g/l;
mixing the zeolite material with the binder blend in solution to produce a mixture;
treating the zeolite material binder blend mixture to form the molecular sieve adsorbent blend product.

3. The process of claim 1 wherein the binder comprises from about 5 to about 30 percent, by weight, of the molecular sieve adsorbent blend.

4. The process of claim 2 wherein the binder comprises from about 5 to about 30 percent by weight of the molecular sieve adsorbent blend.

5. The process of claim 1 further comprising blending a pore forming agent with the zeolite material binder product.

6. The process of claim 2 further comprising blending a pore forming agent with the zeolite material binder blend product.

7. The process of claim 5 wherein the pore forming agent comprises from about 2 to about 15 percent, by weight, of the molecular sieve adsorbent blend.

8. The process of claim 6 wherein the pore forming agent comprises from about 2 to about 15 percent, by weight, of the molecular sieve adsorbent blend.

9. The process of claim 2 wherein the attapulgite binder comprises at least about 20 percent highly dispersed attapulgite fibers.

10. A molecular sieve adsorbent blend product comprising a zeolite material blended with a binder, wherein the binder comprises highly dispersed attapulgite fibers having a tapped bulk density more than about 550 g/l and wherein the zeolite material comprises a mixture of zeolite 13X and zeolite LSX.

11. The product of claim 10 wherein a non-highly dispersed attapulgite binder is blended with the highly dispersed attapulgite fibers to form a binder mixture prior to blending the binder mixture with the zeolite material mixture.

12. The product of claim 10 wherein the highly dispersed attapulgite fibers comprise from about 2 to about 30 percent by weight of the molecular sieve adsorbent blend.

13. The product of claim 11 wherein the blend of the highly dispersed attapulgite fibers and the non-highly dispersed attapulgite binder comprises from about 2 to about 30 percent by weight of the molecular sieve adsorbent blend.

14. The product of claim 10 further comprising a pore forming agent.

15. The product of claim 11 further comprising a pore forming agent.

16. The product of claim 10 wherein the ratio of the zeolite 13X to the zeolite LSX is from about 75:25 to about 60:40.

17. The product of claim 10 wherein cations of the zeolite material comprise at least about 50 to about 95 percent calcium.

18. The product of claim 16 wherein a portion of the cations of the zeolite material are selected from the group consisting of Group III B cations and lanthanide series cations.

19. A process for separation of components of a gaseous or a liquid feed stream comprising
passing the components of the gaseous or liquid feed stream over the molecular sieve adsorbent blend of claim 10.

20. A process for drying a gaseous feed stream comprising passing the feed stream over the molecular sieve adsorbent blend product of claim 10.

21. A process for adsorption of carbon dioxide from an air stream comprising
passing the air stream over the molecular sieve adsorbent blend product of claim 10.

22. A process for removal of water from a gaseous or liquid ethanol stream comprising passing the gaseous or liquid ethanol stream over the molecular sieve adsorbent blend of claim 10.

23. A process for separation of nitrogen and oxygen from an air stream comprising passing the air stream over the molecular sieve adsorbent blend of claim 10.

24. A process for removal of sulfur and oxygen containing compounds from a hydrocarbon stream comprising passing the hydrocarbon stream over the molecular sieve adsorbent blend of claim 10.

25. A process for removal of carbon monoxide, carbon dioxide and nitrogen from a hydrogen gas stream comprising passing the hydrogen gas stream over the molecular sieve adsorbent blend of claim 10.

26. A process for removal of water from a gaseous or liquid hydrocarbon stream comprising passing the gaseous or liquid hydrocarbon stream over the molecular sieve adsorbent blend of claim 10.

27. A process to separate n-paraffins from a mixture of iso-paraffins and n-paraffins comprising passing the mixture over the molecular sieve adsorbent blend of claim 10.

28. A process for removal of water from a gaseous or liquid stream of refrigerants comprising passing the gaseous or liquid stream over the molecular sieve adsorbent blend of claim 10.

29. A process for removal of water and carbon dioxide from air comprising passing the air over the molecular sieve adsorbent blend of claim 10.
